(19) United States
(12) Patent Application Publication
(10) Pub. No.: US 2009/0232945 A1
(43) Pub. Date: Sep. 17, 2009

(54) Fried Food Product

(76) Inventors: Antoinette Arsenault, Belfast, TN (US); Danny Arsenault, Belfast, TN (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 12/048,420

(22) Filed: Mar. 14, 2008

(51) Int. Cl. A23G 3/54; A23P 1/08

(52) U.S. Cl. 426/103; 426/283

(57) ABSTRACT

Disclosed is a fried food product and a method for preparation thereof. The fried food product includes a dough shell, and a combination of at least one chocolate piece, a plurality of confections, and at least one dough cracker. The dough shell includes an inner surface, an outer surface, and a periphery. The combination of the at least one chocolate piece, the plurality of confections, and the at least one dough cracker is placed at a center portion of the inner surface of the dough shell, and the dough shell is folded from the periphery thereof towards the center of the inner surface to enclose the combination therein. The folded dough shell is then fried in oil at a temperature ranging from about 300° C. to about 450° C. for about 2 minutes to about 6 minutes, to obtain the fried food product of the present invention.

### FIELD OF THE INVENTION

The present invention relates to a food product, and more particularly, to a fried food product.

### BACKGROUND OF THE INVENTION

With the advances in today's fast food industry it has become very desirable to prepare and sell food products that are easy-to-cook and easy-to-serve. More specifically, popularity of food products that include desserts has increased over the years due to an availability of delicious varieties thereof. Suitable examples of the desserts include, but are not limited to, cakes, cookies, fruits, pastries, ice creams, and candies. To prepare such desserts, food ingredients that serve as efficient sources for providing delicious taste and aesthetic appearances may be used. Suitable examples of the food ingredients include, but are not limited to, biscuits, flour-based crackers, sweeteners, and the like.

Due to an increase in demand of the desserts at restaurants, parties, eateries, confectioneries, and such similar places, various methods are employed in order to prepare different varieties of the desserts. However, such conventional methods used for preparing the desserts are time-consuming.

Further, the conventional methods may include various complicated steps that require lengthy preparation time. Such complicated steps may include processing of the food ingredients that are used for preparing the desserts. The processing of the food ingredients, more often than not, may result in deteriorating quality of the desserts. Furthermore, due to a lengthy preparation time an end-consumer may desire to prepare the desserts in a simple and a fast manner, which may compromise the taste of the desserts. However, simplifying the conventional methods to quickly prepare the desserts may result in the preparation of sloppy or unstable desserts.

Accordingly, there is a need for a food product to be served as a delicious dessert that may be prepared in an efficient and a reliable manner. Further, there is a need for a method for an easy, and a quick preparation of a firm form of the food product such that quality of the food product is not affected during and after the preparation. Furthermore, there is a need for packaging the food product to provide an easy-to carry form of the food product.

### SUMMARY OF THE INVENTION

In view of the foregoing disadvantages inherent in the prior art, the general purpose of the present invention is to provide a fried food product that serves as a delicious dessert, which includes all the advantages of the prior art, and overcomes the drawbacks inherent therein.

Accordingly, an object of the present invention is to provide a fried food product that may be prepared in an easy and a quick manner.

Another object of the present invention is to provide an easy, quick, and convenient method for preparing a fried food product.

Another object of the present invention is to provide a food product package that includes a fried food product.

In light of the above objects, in one aspect, the present invention discloses a method for preparing a fried food product. The method includes providing a dough shell. The dough shell includes an inner surface, an outer surface, and a periphery. Further, the method includes placing a combination of at least one chocolate piece, a plurality of confectionary materials, and at least one dough cracker at a center portion of the inner surface of the dough shell. Each of the plurality of confectionary materials includes either mucilage or gelatin. Furthermore, the method includes folding the dough shell from the periphery thereof towards the center portion for enclosing the combination inside the dough shell. Additionally, the method includes frying the folded dough shell in oil at a temperature ranging from about 300° C. to about 450° C. for time duration of about 2 minutes to about 6 minutes, to prepare the fried food product.

In another aspect, the present invention discloses a fried food product. The fried food product includes a dough shell, and a combination of at least one dough cracker, at least one chocolate piece, and a plurality of confectionary materials. Each of the plurality of confectionary materials of the combination includes either mucilage or gelatin. The dough shell includes an inner surface, an outer surface, and a periphery. More specifically, the combination is placed at a center portion of the inner surface of the dough shell. Further, the dough shell is capable of being folded from the periphery thereof to enclose the combination therein. The folded dough shell is fried in oil at a temperature ranging from about 300° C. to about 450° C. for time duration of about 2 minutes to about 6 minutes, to prepare the fried food product.

In yet another aspect, the present invention discloses a food product package. The food product package includes a fried food product and a receptacle enclosing the fried food product. The fried food product includes a dough shell, and a combination of at least one dough cracker, at least one chocolate piece, and a plurality of confectionary materials. Each of the plurality of confectionary materials of the combination includes either mucilage or gelatin. The dough shell includes an inner surface, an outer surface, and a periphery. More specifically, the combination is placed at a center portion of the inner surface of the dough shell. Further, the dough shell is capable of being folded from the periphery thereof to enclose the combination therein. The folded dough shell is fried in oil at a temperature ranging from about 300° C. to about 450° C. for time duration of about 2 minutes to about 6 minutes, to prepare the fried food product. The fried food product enclosed within the receptacle facilitates consumers to easily carry the fried food product.

These together with the other aspects of the present invention, along with the various features of novelty that characterized the present invention, are pointed out with particularity in the claims annexed hereto and form a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1A illustrates a perspective view of a fried food product depicting various ingredients thereof, according to an exemplary embodiment of the present invention;

FIG. 1B illustrates a perspective view of the fried food product, according to an exemplary embodiment of the present invention;

FIG. 2 illustrates a front view of a food product package, according to an exemplary embodiment of the present invention; and

FIG. 3 illustrates a flow chart of a method for preparing a fried food product, according to an exemplary embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “a” and “an” herein do not denote a limitation of quantity, but rather denote the presence of at least one of the referenced item.

The present invention provides a fried food product that may be served as a delicious dessert. The fried food product includes ingredients, such as, at least one chocolate piece, a plurality of confectionary materials, at least one dough cracker, and a dough shell. The fried food product is prepared in an easy and a convenient manner. Further, the fried food product is prepared in a short span of time.

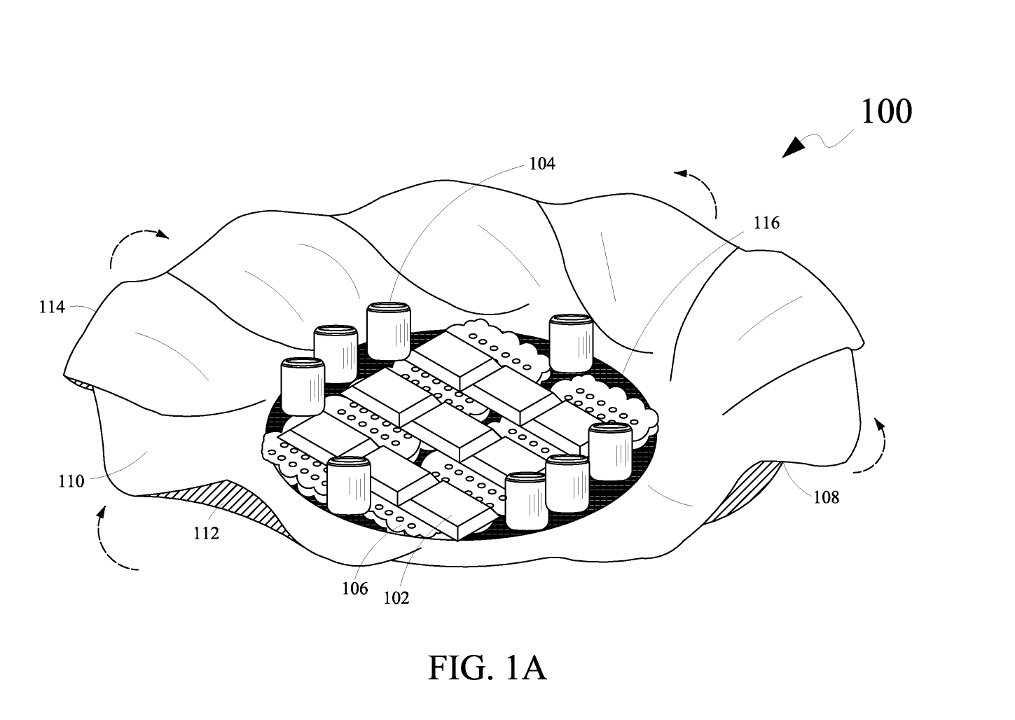

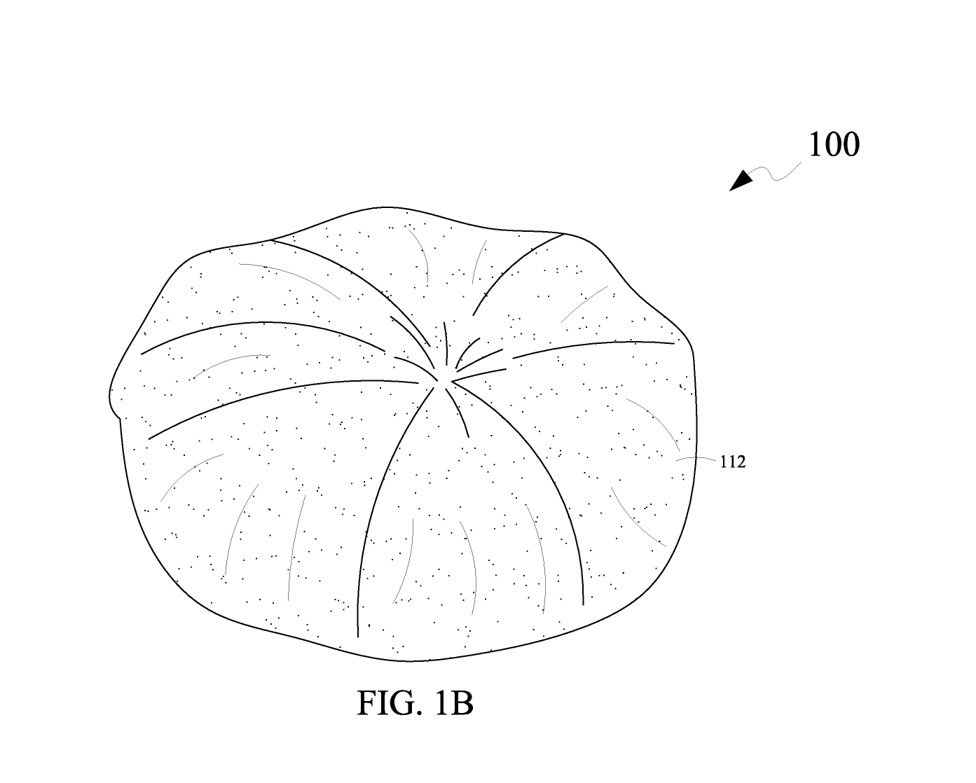

Referring to FIGS. 1A and 1B, a perspective view of the fried food product, such as a fried food product 100, is shown. More specifically, FIG. 1A illustrates a perspective view of the fried food product 100 depicting various ingredients thereof, according to an exemplary embodiment of the present invention. The fried food product 100 includes a combination of at least one chocolate piece 102, (hereinafter referred to as chocolate pieces 102), a plurality of confectionary materials 104 (hereinafter referred to as confections 104), and at least one dough cracker 106 (hereinafter referred to as cracker 106). Further, the fried food product 100 includes a dough shell 108 (hereinafter referred to as shell 108). The shell 108 includes an inner surface 110, an outer surface 112 and a periphery 114. The chocolate pieces 102, the confections 104, and the cracker 106 are combined to form the combination that is enclosed in the shell 108. Subsequently, the shell 108 is fried to prepare the fried food product 100. It should be apparent to a person skilled in the art that cooked and ready-to-use forms of the foregoing ingredients are utilized for preparing the fried food product 100 of the present invention.

More specifically and for the purpose of the description, 6 chocolate pieces 102 may be used while preparing the fried food product 100. The chocolate pieces 102 as disclosed above may be obtained from any commonly available chocolate. The chocolate pieces 102 may be in a form of bars or slabs. In one embodiment of the present invention, the chocolate pieces 102 are obtained from a Hershey's chocolate. More specifically, less than or equal to about 6 bars of the Hershey's chocolate may be used while preparing the fried food product 100. It should be understood that the chocolate pieces 102 may be obtained from chocolates other than the Hershey's chocolates, depending upon cooking requirements or a choice of a consumer.

The confections 104 used in the fried food product 100 may be prepared from a material that includes either a mucilage or gelatin. More specifically, each of the confections 104 includes an extract from a mucilaginous root of a marshmallow plant or a gelatin that has been pre-softened in hot water. Further, the each of the confections 104 may include other ingredients, such as, sugar or corn syrup, water, dextrose, and other flavoring agents. In one embodiment of the present invention, about 20 to about 25 pieces of marshmallows are used as the confections 104. More specifically, the marshmallows such as small-sized marshmallows, referred to as mini marshmallows, may be used for preparing the fried food product 100 of the present invention.

The cracker 106 used in the fried food product 100 may be made from a raw dough. It should be apparent to a person skilled in the art that the raw dough may include flour, bran, and water. The raw dough is formed by mixing the flour, the bran, and the water together. The raw dough may further include a sweetener such as a corn syrup, honey, a maple syrup, a sugar alcohol, and a combination thereof. The raw dough may be molded in a particular shape, such as, a flat circular shape, a flat square shape, or a flat rectangular shape. The molded raw dough may then be cooked to produce the cracker 106 of the present invention. An additional agent such as cinnamon or a chocolate may be used in the cracker 106 to enhance flavor thereof. In one embodiment of the present invention, the cracker 106 is a graham cracker. The graham cracker is made from a coarsely ground hard whole-wheat flour, referred to as graham flour.

Further, the combination (not specifically shown) of the chocolate pieces 102, the confections 104, and the cracker 106 is placed at a center portion 116 of the inner surface 110 of the shell 108. The shell 108 accommodating the combination is sufficiently soft and flexible to adapt any desired configuration. Due to the flexibility, the shell 108 may be folded from the periphery 114 thereof in a desired manner to enclose the combination therein.

More specifically, the periphery 114 of the shell 108 may be folded towards the center portion 116 of the inner surface 110, as indicated by dotted arrows in FIG. 1A. The periphery 114 may be folded towards the center portion 116 to enclose the combination within the shell 108. It is to be understood that preparation of the fried food product 100 includes frying of the folded shell 108, enclosing the combination, to obtain the fried food product 100 having the outer surface 112 that may be crispy in nature, as shown more particularly in FIG. 1B.

It should be understood that the shell 108 may be fried in oil at particular temperature for particular time duration to prepare the fried food product 100 of the present invention. In one embodiment of the present invention, the shell 108 may be deep fried in oil at a temperature ranging from about 300° C. to about 450° C. for time duration of about 2 minutes to about 6 minutes. After frying, the outer surface 112 of the shell 108 may exhibit a golden brown appearance with the crispy nature. Without departing from the scope of the present invention, the shell 108 may be shallow-fried.

In one embodiment of the present invention, the shell 108 is a tortilla shell. However, it should be apparent to a person skilled in the art that the shell 108 may either be made from a white raw dough obtained from corn flour, or from a wheat dough obtained from wheat flour, or a combination thereof. Additional material may be added to the raw dough to enhance properties of the shell 108. After the raw dough is formed, the raw dough may be molded in a shape of the shell 108 using a shell-shaped mold. The shell 108 may acquire an oval shape, a cone shape, or a bowl shape. However, it should be apparent to a person skilled in the art that the shell 108 may be molded in any desired shape depending on a type of a shell-shaped mold being used.

In addition to the aforementioned ingredients of the present invention, the fried food product 100 may include a topping material (not shown). Chocolate syrup, one or more chocolate pieces, an ice cream, a whipped cream, or combinations thereof may be used as suitable topping materials. The topping material may be added on top of the fried food product 100 to impart a delicious and a refreshing taste thereto. Further, the topping material may be added to the fried food product 100 in any desired ratio in order to enhance the taste and aesthetic appearance of the fried food product 100. In one embodiment of the present invention, 6 bars of a Hershey's chocolate may be divided into two portions, each portion of the two portions including 3 bars. Out of the two portions, one portion may be used as an ingredient of the fried food product 100, and other portion of the two portions, may be used as the topping material for the fried food product 100.

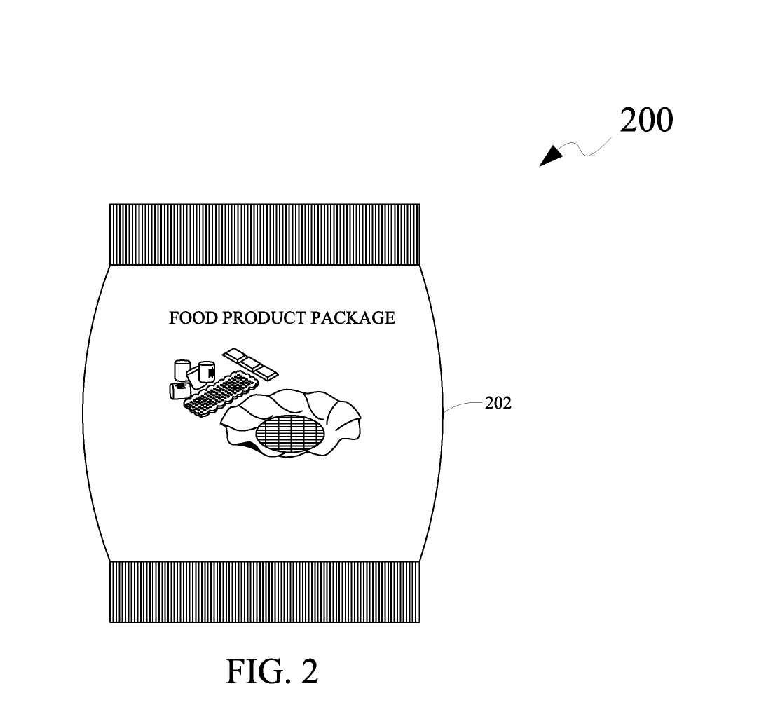

The present invention further discloses a food product package used for storing and packaging the fried food product, such as the fried food product 100 of FIGS. 1A and 1B. The food product package of the present invention is explained in conjunction with FIG. 2.

FIG. 2 illustrates a perspective view of the food product package, such as a food product package 200, according to an exemplary embodiment of the present invention. The food product package 200 may include a fried food product (not shown), similar to the fried food product 100 of FIGS. 1A and 1B, and a receptacle 202. The receptacle 202 encloses the fried food product therein. The receptacle 202 may be made of a material, such as a cardboard material, a plastic material, and a paper material. Further, the receptacle 202 may exhibit a conical shape, a rectangular shape, a square shape, or an oval shape. The receptacle 202 enables a consumer to conveniently hold and carry the fried food product of the present invention. It should be understood that the food product package 200 of the present invention may be a container such as a can, or a bag.

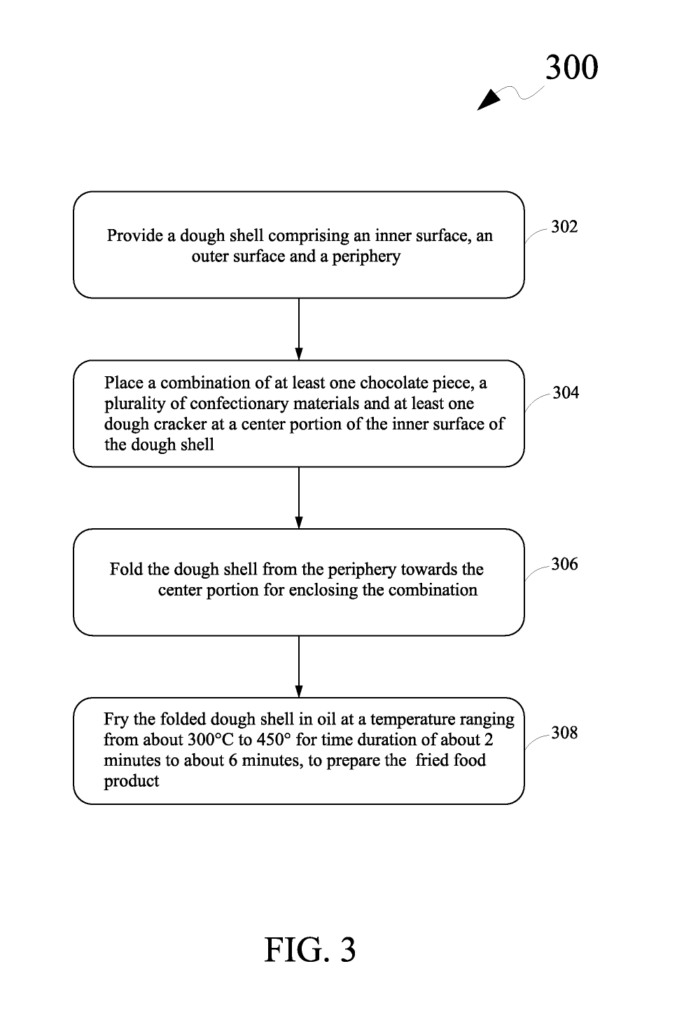

Without departing from the scope, the present invention discloses a quick, efficient, and a reliable method for preparing a fried food product, such as the fried food product 100 of FIGS. 1A and 1B. The method is explained in detail in conjunction with FIG. 3.

FIG. 3 illustrates a flow chart depicting a method 300 for preparing a fried food product, such as the fried food product 100 of FIGS. 1A and 1B, according to an exemplary embodiment of the present invention. The method for preparing the fried food product starts at 302. At 302, a dough shell, such as the shell 108 is provided. More specifically, a cooked form of the dough shell is provided. In one embodiment, a tortilla shell is used as the dough shell for preparing the fried food product. The dough shell includes an inner surface, such as the inner surface 110 of FIG. 1A; an outer surface, such as the outer surface 112 of FIG. 1A; and a periphery, such as the periphery 114 of FIG. 1A.

At 304, a combination of at least one chocolate piece such as the chocolate pieces 102 of FIG. 1A; a plurality of confections, such as the confections 104 of FIG. 1A; and at least one dough cracker, such as the cracker 106 of FIG. 1A; is placed at a center portion, such as center portion 116 of FIG. 1A, of the inner surface of the dough shell. In one embodiment of the present invention, the at least one chocolate piece may be obtained from any commonly available chocolate, such as a Hershey's chocolate. 3 bars of the Hershey's chocolate may be placed at the center portion of the inner surface of the dough shell. Each of the plurality of confections placed at the center portion may include mucilage or gelatin. Further, the each of the plurality of confections may include other ingredients, such as, sugar or corn syrup, water, dextrose, and other flavoring agents. In one embodiment of the present invention, about 20 to about 25 pieces of marshmallows are used as the plurality of confectionary materials in the fried food product. More specifically, small-sized marshmallows, referred to as mini marshmallows, may be used while preparing the fried food product of the present invention. The at least one dough cracker used for preparing the fried food product may be made from a raw dough including flour, bran, and water as essential ingredients. In one embodiment of the present invention, at least one graham cracker may be used as the at least one dough cracker for preparing the fried food product of the present invention. It should be understood that the combination of the at least one chocolate piece, the plurality of confections, and the at least one dough cracker may be placed at the center portion of the inner surface of the dough shell in any desired order. Further, it should be understood that cooked and ready-to-use forms of the combination including the at least one chocolate piece, the plurality of confections, and the at least one dough cracker may be utilized for preparing the fried food product of the present invention.

At 306, the dough shell is folded from the periphery thereof towards the center portion of the inner surface to enclose the combination of the at least one chocolate piece, the plurality of confections, and the at least one dough cracker within the dough shell. The dough shell, enclosing the combination, is sufficiently soft and flexible. Due to the flexibility, the dough shell may be folded from the periphery thereof in a desired manner, thereby providing a specific configuration or shape thereto. The dough shell enclosing the combination may acquire an oval shape, a conical shape, or a bowl shape. However, it should be apparent to a person skilled in the art that the dough shell may be molded in any aesthetically desired shape.

At 308, the dough shell enclosing the combination is fried in oil at a temperature ranging from about 300° C. to about 450° C. for time duration ranging from about 2 minutes to about 6 minutes to prepare the fried food product having a crispy and a golden brown outer surface. More specifically, the fried food product may be prepared by deep-frying the dough shell, enclosing the combination, for time duration of less than about 6 minutes. Therefore, the method disclosed herein provides a delicious fried food product in a short span of time without compromising the quality and nutritional content thereof.

It should be understood that the respective ranges of the temperature and the time duration required to prepare the fried food product may vary depending upon a level of frying, for example, the dough shell, enclosing the combination may be deep-fried or shallow-fried to prepare the fried food product of the present invention.

Further to 308, and according to one embodiment of the present invention, the method of the present invention may include dressing the fried food product, as prepared and obtained at 308, using a topping material. The topping material may be selected from the topping materials as disclosed in the description of FIGS. 1A and 1B. The topping material is added to the fried food product to impart a delicious and a refreshing taste thereto. The topping material may be added to the fried food product in any desired ratio to enhance the taste and the aesthetic appearance of the fried food product of the present invention.

Various embodiments of the present invention provide the following advantages. The present invention provides a fried food product that may be served as a delicious dessert at parties, eateries, confectioneries, restaurants, and such similar places. More specifically, the fried food product of the present invention is of utmost importance as the fried food product is prepared easily and quickly in a reliable manner. Accordingly, the present invention also provides an effective method for preparing the fried food product in a simple, reliable, and a time-saving manner. Moreover, the method of the present invention results in the preparation of a compact and a firm form of the fried food product that may conveniently and easily be utilized by consumers. In addition, the method disclosed herein serves as an effective tool for the preparation of a home-made form of a dessert obtained in a short span of time without incurring innumerable efforts. Further, the fried food product may be enclosed in a package to provide an easy-to-carry or portable form of the fried food product.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present invention.

What is claimed is:

1. A method for preparing a fried food product, the method comprising:
providing a dough shell comprising an inner surface, an outer surface, and a periphery;
placing a combination of at least one chocolate piece, a plurality of confectionary materials, each of the plurality of confectionary materials comprising at least one of mucilage and gelatin, and at least one dough cracker at a center portion of the inner surface of the dough shell;
folding the dough shell from the periphery towards the center portion for enclosing the combination; and
frying the folded dough shell in oil at a temperature ranging from about 300° C. to about 450° C. for time duration of about 2 minutes to about 6 minutes, to prepare the fried food product.

2. The method of claim 1 further comprising dressing the fried food product with a topping material, wherein the topping material is at least one of chocolate syrup, a chocolate piece, an ice cream, a whipped cream, and combinations thereof.

3. The method of claim 1, wherein the at least one dough cracker is a graham cracker.

4. The method of claim 1, wherein each of the plurality of confectionary materials is a marshmallow.

5. The method of claim 1, wherein the dough shell is a tortilla shell.

6. The method of claim 1, wherein the dough shell exhibits a shape selected from the group consisting of a round shape, an oval shape, a conical shape, and a bowl shape.

7. A fried food product, comprising:
a combination of at least one dough cracker, at least one chocolate piece, and a plurality of confectionary materials, each of the plurality of confectionary materials comprising at least one of mucilage and gelatin; and
a dough shell comprising an inner surface, an outer surface, and a periphery, the dough shell folded from the periphery to enclose the combination placed at a center portion of the inner surface of the dough shell, the folded dough shell fried in oil at a temperature ranging from about 300° C. to about 450° C. for time duration of about 2 minutes to about 6 minutes, to prepare the fried food product.

8. The fried food product of claim 7, wherein the at least one dough cracker is a graham cracker.

10. The fried food product of claim 7, wherein the each of the plurality of confectionary materials is a marshmallow.

11. The fried food product of claim 7, wherein the dough shell is a tortilla shell.

12. The fried food product of claim 7, wherein the dough shell exhibits a shape selected from the group consisting of a round shape, an oval shape, a conical shape, and a bowl shape.

13. The fried food product of claim 7, further comprising a topping material, wherein the topping material is at least one of chocolate syrup, a chocolate piece, an ice cream, a whipped cream, and combinations thereof.

14. A food product package, comprising:
a fried food product comprising,
a combination of at least one dough cracker, at least one chocolate piece, and a plurality of confectionary materials, each of the plurality of confectionary materials comprising at least one of mucilage and gelatin, and
a dough shell comprising an inner surface, an outer surface, and a periphery, the dough shell folded from the periphery to enclose the combination placed at a center portion of the inner surface of the dough shell, the folded dough shell fried in oil at a temperature ranging from about 300° C. to about 450° C. for time duration of about 2 minutes to about 6 minutes, to prepare the fried food product; and
a receptacle enclosing the fried food product.
